(19) United States
(12) Patent Application Publication
(10) Pub. No.: US 2012/0143928 A1
(43) Pub. Date: Jun. 7, 2012

(54) FILE SYSTEM TRANSACTION LOG FLUSH OPTIMIZATION

(76) Inventors: FILIP YANKOV, Burgas (BG); DIMITAR DIMITROV, Sofia (BG); Vania Slavchova Dimitrova, Sofia (BG); Ivan Dimitrov Dimitrov, Sofia (BG); NIKOLAI TANKOV, Sofia (BG)

(21) Appl. No.: 12/961,506

(22) Filed: Dec. 7, 2010

(51) Int. Cl. G06F 17/30

(52) U.S. Cl. 707/826; 707/E17.01

(57) ABSTRACT

Various embodiments of systems and methods for file system transaction log flush optimization are described herein. An optimizer is working as an intelligent processing unit, autonomously determining the best possible time to flush all collected transaction data modifications to the file system when operating under high load, or flushing each modification separately under low load. When operating under high load, batches of data modifications are collected and written together to the file system in a single write operation, thus decreasing the number of write operations and achieving better utilization of the system resources.

### FIELD

The field relates to optimization of data writes to file systems. More precisely, the field relates to optimization of data writes to file systems according to the current load of processing data.

### BACKGROUND

There are various modules within complex computer applications. Some of these modules are responsible for managing how, when and where transaction information is to be persisted on the file system of a computer system. Sometimes the computer system will operate under high load, which means that many transactions will be concurrently committed, rolled back and/or recovered. All these transactions may be referred to as “passing” through the system. If the number of these transactions is large, writing the data to the file system for each transaction separately will deteriorate system performance, potentially even to the point of causing system crashes. Moreover, the file system is a single resource, therefore if we choose to serialize transaction data separately for each transaction, it will become a bottleneck. A smart solution for that case is collecting batches of data modifications and writing them to file system together, in a single write operation. In this way, the number of write operations decreases and the system is able to better utilize the CPU and other resources. The second case is when the system is not so loaded with “passing” transactions. Then there is no need for collecting transaction data in batches and writing the data for more than one transaction in a single write operation to file system, because the system could crash due to external factors and in the process the information which has been collected in the volatile memory of the system may be lost. In other words, flushing file writes done in batches optimizes performance at the cost of higher probability of data loss in case of system crash, which means an optimal solution is switching between these two options, depending on the current “passing” transactions load. The load of real-life systems varies constantly between the two borderline cases. Therefore the system should be able to appropriately handle the two cases and should be able to switch instantly between them.

### SUMMARY

Various embodiments of systems and methods for file system transaction log flush optimization are described herein. In one embodiment, the method includes monitoring a current load of transaction information to be persisted on the file system, the transaction information comprising a set of records committed to the file system. The method also includes collecting the set of records at a buffer and flushing the buffer to the file system when the current load of the transaction information is above a predefined limit indicating high transaction load. The method further includes writing the committed set of records one by one without a mediation of the buffer when the current load of the transaction information is below a predefined limit indicating low transaction load.

In other embodiments, the system includes at least one processor for executing program code and memory, a file system repository, and a set of transaction records to be persisted on the file system repository. The system also includes a monitoring module within the memory, the monitoring module to monitor a current load of transaction records to be persisted on the file system repository and a collector module within the memory, the collector module to collect the set of transaction records at a buffer. The system further includes a flusher module within the memory, the flusher module to flush the buffer to the file system repository when the current load of the transaction records is above a predefined limit indicating high transaction load and a writer module within the memory, the writer module to write the set of records one by one without a mediation of the buffer when the current load of transaction records is below a predefined limit indicating low transaction load.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram representing persisting of transaction information in a computer system.

FIG. 2 is a flow diagram of an embodiment of a method for persisting transaction information.

FIG. 3 is a block diagram of an embodiment of a system for persisting transaction information.

FIG. 4 is a block diagram illustrating a computing environment in which the techniques described for persisting transaction information can be implemented, according to an embodiment of the invention.

### DETAILED DESCRIPTION

Embodiments of techniques for file system transaction log flush optimization are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

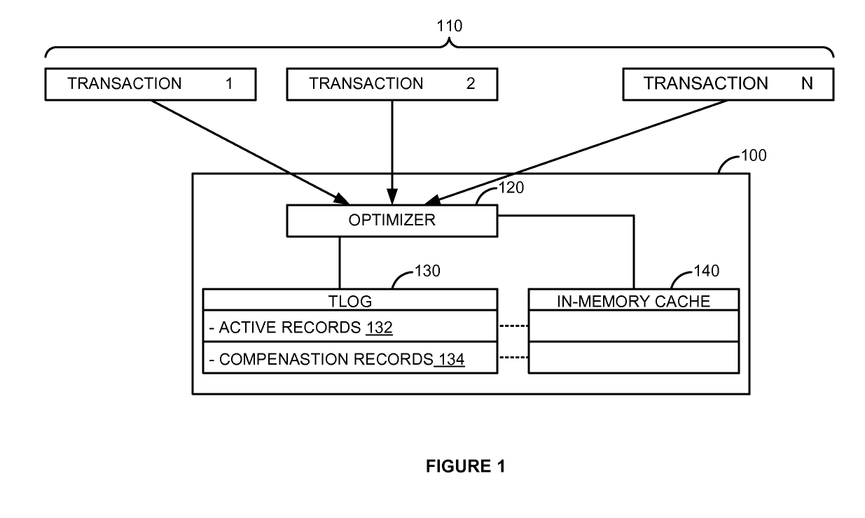

FIG. 1 represents a block diagram of a computer system 100 and transactions 110 forming a transaction load, “passing” through the system 100. An optimizer 120 works as an intelligent processing unit to determine the best possible time to flush all collected transactions 110 to the file system when operating under high load, or flushing each modification separately under low load. The optimizer 120 writes in one TLOG (Transaction LOG) file 130 the information required for processing the current transaction in the system. For each transaction from the transactions 110, two types of records are written in the TLOG file 130—records for successfully prepared transactions (called active records 132) and records for successfully completed transactions (called compensation records 134). Compensation records 134 are equivalent to removal of the corresponding active record 132 for the current transaction from the TLOG file 130. All operations on the TLOG file 130 are also dubbed in-memory, i.e. there is in-memory cache 140 of the active records 132 and the compensation records 134. During normal operation, the optimizer 120 retrieves information about the active and compensation records only from the in-memory cache 140. The TLOG file 130 is used only for writing as a journal. If the system 100 crashes, the TLOG file 130 is read in order to restore the in-memory state of the optimizer 120. A large number of transactions 110 could be completed within a short time interval and searching for a record of a prepared transaction corresponding to the last completed one to be removed from the TLOG file 130, could significantly lower system performance. Therefore, active records 132 are not searched for and removed, but a compensation record 134 (equivalent to the remove operation of the corresponding active record 132) is written. At a later phase, such compensation records 134 are used to remove their corresponding active records 132 altogether from the TLOG file 130. This is not optimal because for each transaction from the transactions 110, two records are written in the TLOG file 130, and if the transaction load is high, this means that the file system input/output (I/O) operations (i.e. file writes) are too many.

To avoid this suboptimal behavior, active records 132 and compensation records 134 are stored also in the in-memory cache 140 for a certain period of time, thus the records being buffered and further written by a single flush operation in the TLOG file 130. This is done in order to optimize the usage of system resources (main memory, CPU). The moment for this flush is dynamically determined by the optimizer 120 and depends on transaction load. The factors taken into account for the flush moment are the number of “empty” flushes into the TLOG file 130; the timeout between two consecutive flushes; the maximum number of records stored in the in-memory cache 140 before being written in the TLOG file 130; and the number of records written in the previous flush operation (called last flush size). The first three factors can be configured depending on the system characteristics (hard disk performance, CPU, main memory available, etc.). An empty flush is defined as a flush in which 0 or 1 records are written in the TLOG file 130. If the number of consecutive empty flushes exceeds some constant value (10 for example), this indicates low transaction load and the optimizer 120 is switched off, because the overhead it incurs no longer pays off. In this mode, writing in the TLOG file 130 is done as soon as a transaction is prepared or completed, without buffering of records into main memory. The optimizer 120 is switched on again if a second transaction is successfully prepared while another record is being flushed in the TLOG file 130. Otherwise, this successfully prepared transaction (and following ones) would have to wait for the completion of the ongoing flush, delaying their execution.

In one embodiment, two events can trigger a flush: buffer overflow, which is exceeding the maximum number of records that can be stored in the in-memory cache 140, or exceeding the timeout between two consecutive flushes (25 milliseconds for example). When flush is triggered, the whole content of the buffer is written into the TLOG file 130 and the buffer is “emptied”. While emptying the buffer, no physical memory release is done—only the index in the buffer for the next transaction record to be stored is reset to 0, which means subsequent records overwrite the old ones. In one embodiment, the default value of this timeout is determined to correspond to an upper bound of the minimum latency between two consecutive I/O operations on a contemporary hard disk. If this timeout is too small, the hard disk will be unable to execute the flush operations in real time and will start some low-level buffering. If the timeout is too big, the risk of losing data due to system crash increases. In one embodiment, the default size of the buffer is set to 100; it is recommended to correspond to the maximum number of application threads running in parallel.

Besides the configurable properties, in one embodiment, the optimizer 120 is self-adapting to the transaction load and system performance, deciding to flush the buffer before any of the two above-described configurable limits is reached. The optimizer 120 maintains a dynamically calculated flush trigger parameter—“next flush size limit”. When the number of pending records in the buffer exceeds this parameter, flush is triggered. The parameter is calculated upon flush by the formula:

nextFlushSizeLimit=2*currentFlushSize−lastFlushSize,

where

currentFlushSize is the number of pending transaction records to be flushed currently and

lastFlushSize is the number of transaction records written with the previous flush. The formula is based on the assumption that the load varies linearly between consecutive flushes.

During flush, the buffer must be locked. In order to prevent blocking of other incoming transactions, the optimizer 120 maintains two buffers—one is active and upon flush it is locked, and the other becomes active, and so on. Since the TLOG file 130 grows with time, when its size reaches some predefined limit (8 MB for example), further flushes are locked, the in-memory cache 140 of the TLOG file 130 is recalculated (subtracting the compensation records 134 from the active records 132), a new TLOG file 130 is created and the active records 132 are flushed to it. Then the old TLOG file 130 is deleted and the flushes are unlocked.

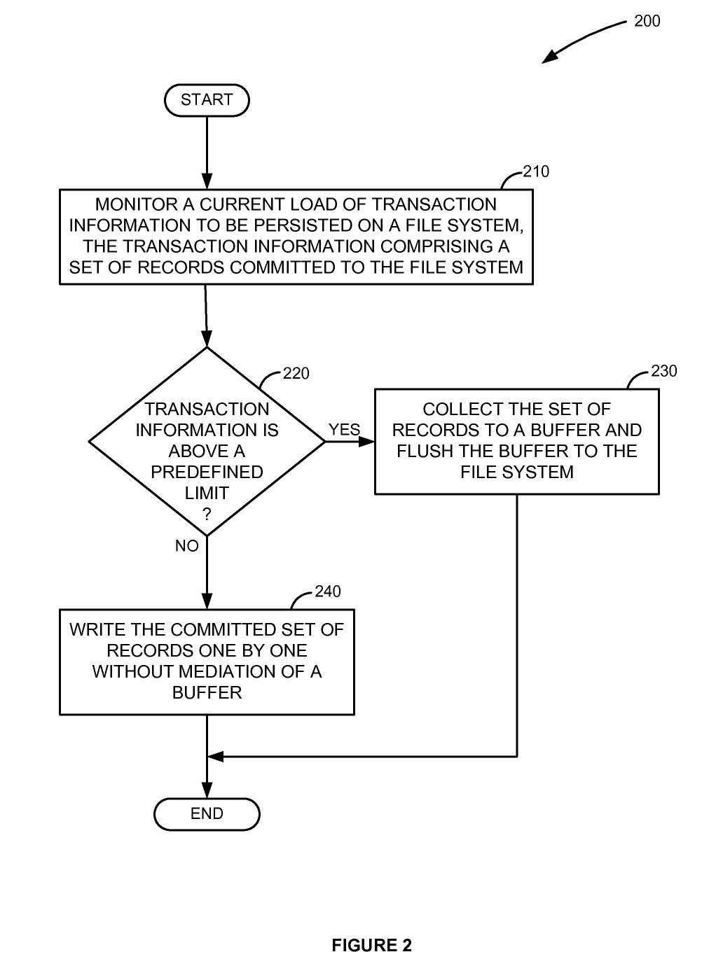

FIG. 2 is a flow diagram of an embodiment of a method 200 for persisting transaction information on a file system of a computer. The method begins at block 210 with monitoring a current load of transaction information to be persisted on the file system. The transaction information comprises a set of records committed to the file system.

At decision block 220, a check is performed to determine whether the transaction information is above a predefined limit. If the transaction information is above a predefined limit indicating high transaction load, at block 230 the set of records are collected at a buffer and the buffer is flushed to the file system. In one embodiment, the buffer is flushed when the buffer is full or a predefined timeout has passed. This means the flush is triggered either when the maximum number of records that may be stored in the buffer is reached or a predefined timeout between two consecutive flushes is exceeded. In one embodiment the flush is triggered by another event, which is reaching a flush size limit, which is less than the maximum number of records that may be stored in the buffer. In one embodiment, the flush size limit is dynamically calculated. In yet another embodiment, the dynamically calculated flush size limit increases, when the load of transaction information rises, and decreases, when the load of transaction information diminishes. In one embodiment the dynamically calculated flush size limit increases or decreases linearly.

If at block 220, the transaction information is defined as below a predefined limit indicating low transaction load, the method continues at block 240 with writing the committed set of records one by one without mediation of a buffer. In one embodiment low transaction load is indicated by a predefined number of empty flushes of the buffer to the file system. In one embodiment, an empty flush is defined as a flush in which zero or one records are flushed.

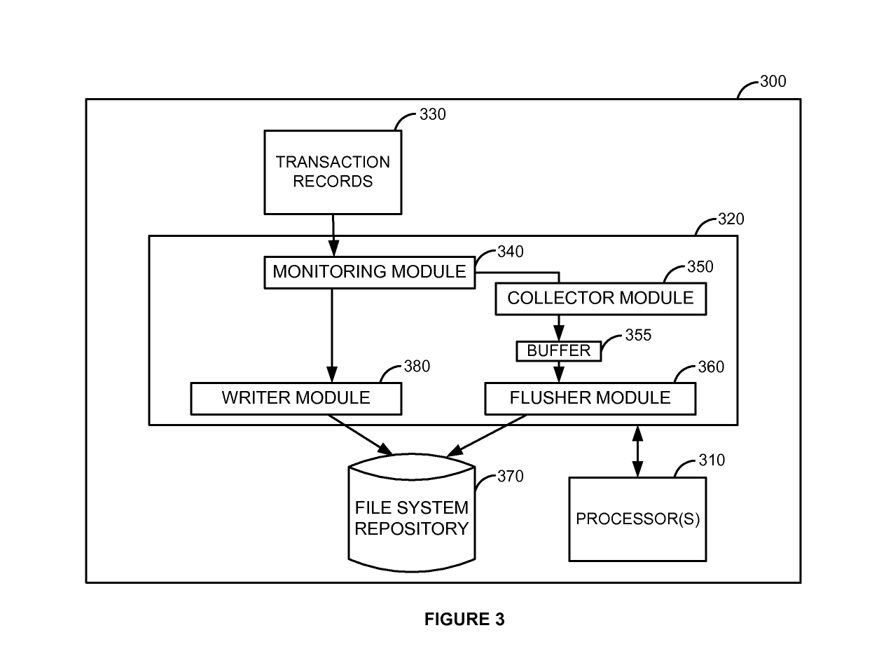

FIG. 3 is a block diagram of an embodiment of a computer system 300 for persisting transaction information. The system includes one or more processors 310 for executing program code. Computer memory 320 is in connection to the one or more processors 310. The system 300 further includes a file system repository 370 and transaction records 330 passing through the system 300 to be persisted on the file system repository 370. The memory 320 also includes a monitoring module 340, a collector module 350, a buffer 355, a flusher module 360, and a writer module 380. The monitoring module 340 is intended to monitor a current load of the transaction records 330 to be persisted on the file system repository 370. When a high transaction load is indicated by the monitoring module 340, the collector module 350 collects the transaction records 330 from the monitoring module 340 at a buffer 355 and further the flusher module 360 flushes the buffer 355 to the file system repository 370. In one embodiment, the flusher module 360 flushes the buffer 355 to the file system repository 370 when the buffer 355 is full or a predefined timeout has passed. This means the flush is triggered either when the maximum number of records that may be stored in the buffer 355 is reached or a predefined timeout between two consecutive flushes is exceeded. In another embodiment, the flush of the buffer 355 may be triggered by another event, which is reaching a flush size limit, which is less than the maximum number of transaction records 330 that may be stored in the buffer 355. In one embodiment, the flush size limit is dynamically calculated. In one another embodiment, the dynamically calculated flush size limit increases or decreases linearly, according to the current load of transaction records 330 measured by the monitoring module 340.

When a low transaction load is indicated by the monitoring module 340, the writer module 380 writes the transaction records 330 one by one to the file system repository 370 without a mediation of the buffer 355. In one embodiment, a low transaction load is indicated by reaching a predefined number of empty flushes of the buffer 355 to the file system repository 370. In one embodiment, an empty flush is defined as a flush in which zero or one transaction records 330 are flushed by the flusher module 360 to the file system repository 380.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

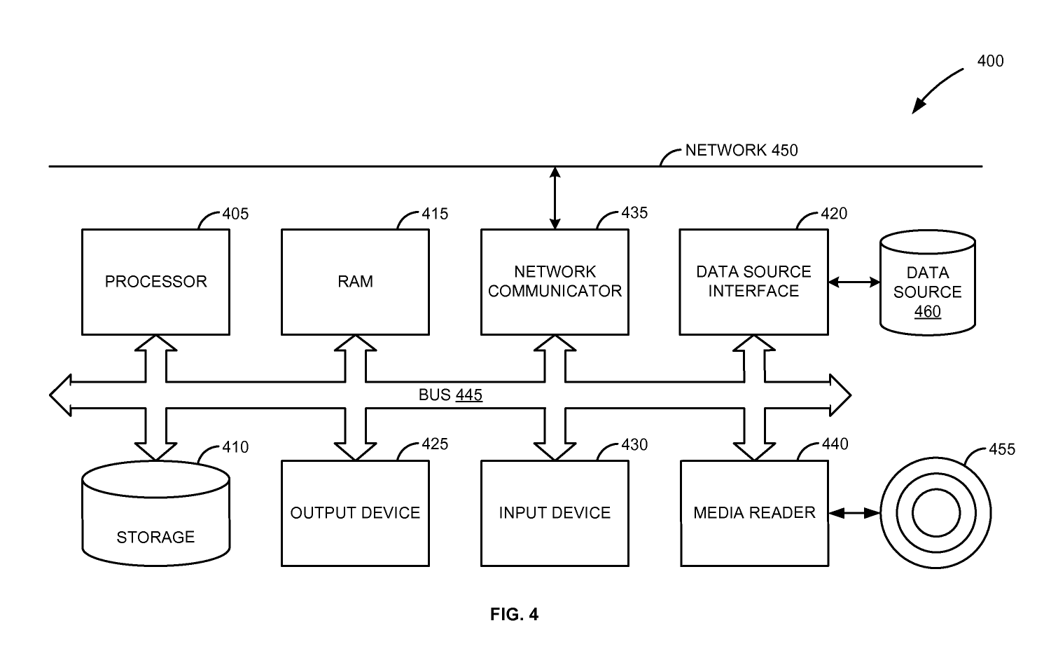

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
monitor a current load of transaction information to be persisted on a file system, the transaction information comprising a set of records committed to the file system;
collect the set of records at a buffer;
flush the buffer to the file system when the current load of the transaction information is above a predefined limit indicating a high transaction load; and
write the committed set of records one by one without a mediation of the buffer when the current load of the transaction information is below a predefined limit indicating low transaction load.

2. The article of manufacture of claim 1, wherein flushing the buffer to the file system is performed when the buffer is full or a predefined timeout has passed.

3. The article of manufacture of claim 1, wherein the low transaction load is indicated by a predefined number of empty flushes of the buffer to the file system.

4. The article of manufacture of claim 1, wherein flushing the buffer to the file system is performed upon reaching a flush size limit.

5. The article of manufacture of claim 4, wherein the flush size limit is dynamically calculated.

6. The article of manufacture of claim 5, wherein the dynamically calculated flush size limit increases when the load of transaction information rises and decreases when the load of transaction information diminishes.

7. The article of manufacture of claim 6, wherein the dynamically calculated flush size limit increases or decreases linearly.

8. A computerized method for persisting transaction information on a file system of a computer, the computer including at least one processor for executing program code and memory for persisting the transaction information, the method comprising:
monitoring a current load of transaction information to be persisted on the file system, the transaction information comprising a set of records committed to the file system;
collecting the set of records at a buffer;
flushing the buffer to the file system when the current load of the transaction information is above a predefined limit indicating high transaction load; and
writing the committed set of records one by one without a mediation of the buffer when the current load of the transaction information is below a predefined limit indicating low transaction load.

9. The method of claim 8, wherein flushing the buffer to the file system is performed when the buffer is full or a predefined timeout has passed.

10. The method of claim 8, wherein the low transaction load is indicated by a predefined number of empty flushes of the buffer to the file system.

11. The method of claim 8, wherein flushing the buffer to the file system is performed upon reaching a flush size limit.

12. The method of claim 11, wherein the flush size limit is dynamically calculated.

13. The method of claim 12, wherein the dynamically calculated flush size limit increases when the load of transaction information rises and decreases when the load of transaction information diminishes.

14. The method of claim 13, wherein the dynamically calculated flush size limit increases or decreases linearly.

15. A computer system for persisting transaction information including at least one processor for executing program code and memory, the system comprising:
a file system repository;
a set of transaction records to be persisted on the file system repository;
a monitoring module within the memory, the monitoring module to monitor a current load of transaction records to be persisted on the file system repository;
a collector module within the memory, the collector module to collect the set of transaction records at a buffer;
a flusher module within the memory, the flusher module to flush the buffer to the file system repository when the current load of the transaction records is above a predefined limit indicating high transaction load; and
a writer module within the memory, the writer module to write the set of records one by one without a mediation of the buffer when the current load of transaction records is below a predefined limit indicating low transaction load.

16. The system of claim 15, wherein the flusher module flushes the buffer to the file system repository when the buffer is full or a predefined timeout has passed.

17. The system of claim 15, wherein the low transaction load is indicated by a predefined number of empty flushes of the buffer to the file system repository.

18. The system of claim 15, wherein the flusher module flushes the buffer to the file system repository upon reaching a flush size limit.

19. The system of claim 18, the flush size limit is dynamically calculated.

20. The system of claim 19, wherein the flush size limit increases or decreases linearly according to the current load of transaction records.
